(19) United States
(12) Patent Application Publication
(10) Pub. No.: US 2019/0228297 A1
(43) Pub. Date: Jul. 25, 2019

(54) Artificial Intelligence Modelling Engine

(71) Applicants: Yuan Shen, Bellevue, WA (US); Jiang Ning, Bellevue, WA (US)

(72) Inventors: Yuan Shen, Bellevue, WA (US); Jiang Ning, Bellevue, WA (US)

(21) Appl. No.: 15/876,683

(22) Filed: Jan. 22, 2018

(51) Int. Cl. G06N 3/08; G06N 3/00; G06N 3/04

(52) U.S. Cl. CPC G06N 3/08; G06F 17/28; G06N 3/04; G06N 3/006

(57) ABSTRACT

Techniques are provided which may allow an artificial intelligence modeling engine to be used for multiple applications. A user may configure models without detailed knowledge, which may allow broader use of artificial intelligence engines. Operators optimized in one model may be applied to data with similar attributes in another model.

### FIELD

This disclosure relates to an artificial intelligence (AI) modeling engine.

### BACKGROUND

Companies have been using artificial intelligence to reduce labor for many tasks. Setting up a system requires developing an engine dedicated to solving specific problems. For example, a help desk may build a system to classify questions into technical topics. This involves creating a natural language processing (NLP) front end to parse questions typed by users. An engine must be built and trained using existing questions that have been previously classified.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, an artificial intelligence modeling engine which may support automatically designing or hosting AI models. The artificial intelligence modeling engine may include a chatbot to answer questions or provide questions and use provided answers to resolve issues, for example, and may use artificial intelligence to improve prompts over time.

The system may also be used to customize artificial intelligence models for various applications. For example, one user may want a model to work for a help desk, while another may want a model to provide a medical diagnosis. A model may include operators, also known as modules, that may be refined and reused for different applications.

### BRIEF DESCRIPTION OF THE DRAWINGS

The present description may be better understood from the following detailed description read in light of the appended drawings, wherein:

FIG. 1 is a block diagram of one aspect of an artificial intelligence modeling engine.

FIG. 2 illustrates a graph of one model of an artificial intelligence modeling engine.

FIG. 3 illustrates a graph of another model of an artificial intelligence modeling engine.

FIG. 4 is a graph illustrating an example of meta-learning.

FIG. 5 is a block diagram illustrating an example of a system capable of supporting an artificial intelligence modeling engine, according to one embodiment.

FIG. 6 is a component diagram of a computing device which may support an artificial intelligence modeling engine process according to one embodiment.

### DETAILED DESCRIPTION

A more particular description of certain embodiments of an artificial intelligence modeling engine may be had by reference to the embodiments shown in the drawings that form a part of this specification, in which like numerals represent like objects.

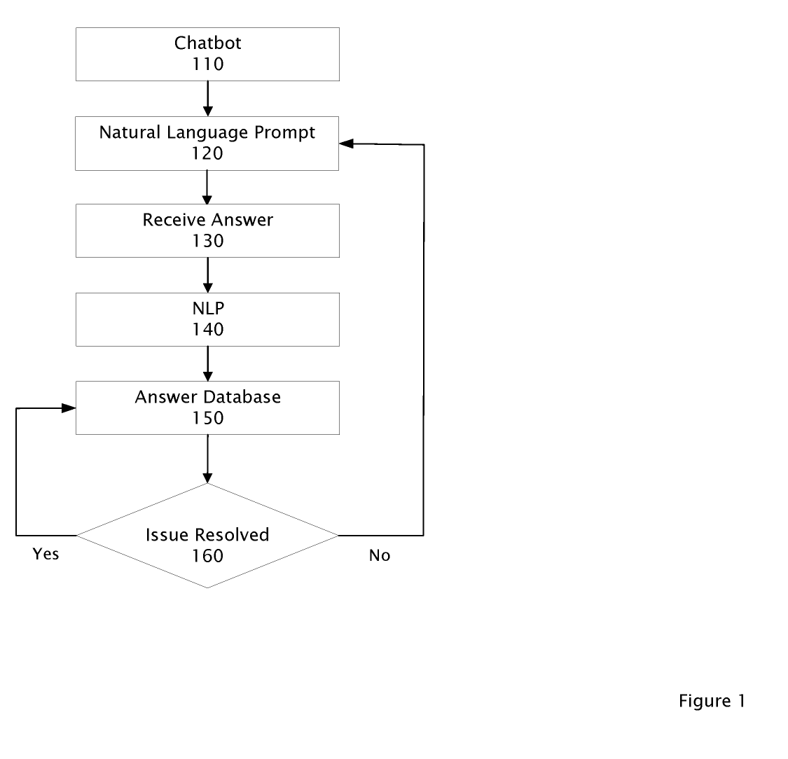

FIG. 1 is a block diagram of one aspect of Artificial Intelligence Modeling Engine 200. Chatbot 110 may be used for various applications, for example, to provide technical support. Chatbot 110 may offer a Natural Language Prompt 120, for example asking a question to narrow down an issue a user may have. In another embodiment, a user may ask Chatbot 110 a question. Chatbot 110 may Receive Answer 130, and use Natural Language Processing (NLP) 140 to parse the answer or the question, and determine an appropriate search in Answer Database 150. If results of that search do not Resolve Issue 160 (No), flow may continue with another Natural Language Prompt 120. If Issue Resolved 160 (Yes), Answer Database 150 may be refined using artificial intelligence to improve Natural Language Prompt 120 for another time this issue may arise. Resolving the issue may include, for example, returning an answer to a question, canceling a job, building a new model, or sending a message to technical support.

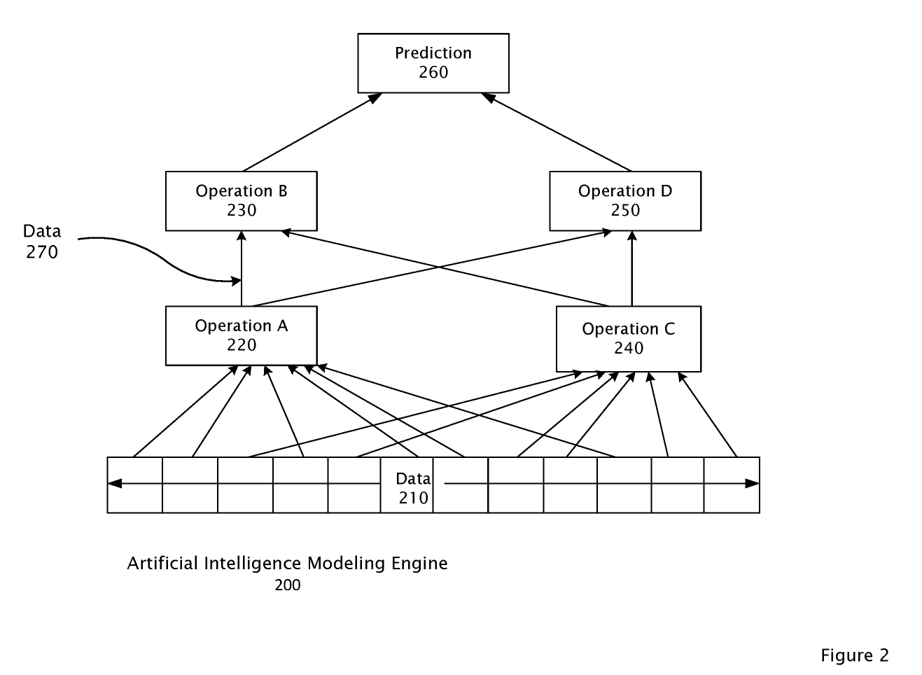

FIG. 2 illustrates a graph of one model of Artificial Intelligence Modeling Engine 200. Artificial intelligence is often used for predicting an output based on input data. Data 210 may be any type of data, including, for example, text, binary, images, audio, video, or combination of data types. Data 210 may be, for example, a database, with each block representing a column. In another example, each block may represent an image. Data 270 may be processed by Operation A, and may be of a different type than Data 210. Data may refer to raw data input to a model, or data output by an operation.

Depending on an attribute, for example, a value contained in a block or a type of block, the block may be sent through Operator A 220 or Operator C 240. For example, if a block in Data 210 is a JPG file, it may be sent through Operator A 220, while if it is a PNG file, it may be sent through Operator C 240. In another example, if a block contains a positive number or zero, it may be sent through Operator A 220, while if it contains a negative number, it may be sent through Operator C 240. Attributes used to determine which operator to use may be, for example, a source or the nature of data, like image, text in a specific language, time-series, unique ids, audio, or speech; a type used to represent the data, like int, float-point, string, dates, arrays of any dimension, semantic types, such as categorical which cannot be compared with each other, numeric, or sequential; array-specific properties, like rank, shape, for example a Recurrent NN may require an input to be an array of rank 3; other constraints between inputs, for example, if more than one input is required, like to compute cosine similarity, two inputs may need to have the same shape or rank; a hyperparameter operator's input condition arrays may need to fit the operator that the hyperparameter operator is controlling; or an operator may require that the input is a distribution, like the sum of the numbers along an axis being required to total one.

One having skill in the art will recognize that many different types of attributes may be used to determine an appropriate operator to perform on a block of data.

Depending on an attribute of an output from Operator A 220, data may be processed through Operator B 230 or Operator D 250. Similarly, depending on an attribute of an output from Operator C 240, data may be processed through Operator B 230 or Operator D 250. Output from Operator B 230 or Operator D 250 may be used to determine Prediction 260.

Operators A 220, B 230, C 240, or D 250 may be any operator appropriate for the type of data being processed. For example, if the data is numeric, the operators may be addition, multiplication, statistical functions, or any other numeric function. If the data is text, an operator may convert the text to tokens, may translate the text from one language to another, may convert text to uppercase, may search for a substring, or may be any other text function. One having skill in the art will recognize that many different operators may be appropriate depending on the type of data.

Operators may also be layers or multiple layers of neural operators, for example, a fully connected layer, a convolution layer, an embedding layer, or an activation function. Neural network layers may communicate both ways, rather than taking one or more inputs and generating outputs. They hold internal states or weights, and the weights may be updated by the operators that follow after them through back-propagation.

Operators may also be trained using training data of the same format. Operators may hold internal states that may be trained using customer data in order to provide better results. Training may include passing training data through an operator and providing correct outputs to the operator for the training data, which may allow the operator to update internal weighting or other status so that the operator may provide correct outputs for other data.

Operators may also perform similar functions through different means, and Artificial Intelligence Modeling Engine 200 may use more than one implementation for data and compare outputs when determining a prediction.

Operators may be atomic, or may be made up of several other operators. Any number of operators may be used. Some operators may map an input to an output that may be used for input to another operator. An operator may have constraints on input types or values. For example, an operator performing a real square root may have a constraint that any input must be a positive real number.

Artificial Intelligence Modeling Engine 200 may be prepopulated with operators for many types of data. For example, Artificial Intelligence Modeling Engine 200 may have many text operators, many numeric operators, many image processing operators, and operators for other types of data. With a graph filled with many possible operators, a user may specify some aspects of what the type of data the user has and what the user may want to have predicted, and Artificial Intelligence Modeling Engine 200 may determine which operators to use. The user may not need to be knowledgeable about the operators to provide enough information to Artificial Intelligence Modeling Engine 200 to produce an effective prediction model.

Artificial Intelligence Modeling Engine 200 may improve itself over time by analyzing which operators provide the best predictions. For example, if a model is meant to determine how much a person can afford to spend on a house, Artificial Intelligence Modeling Engine 200 may calculate a mean, a median, and a mode of income for people who successfully handled payments of a similar size. Artificial Intelligence Modeling Engine 200 may determine that mean is the most effective predictive operator, or that mean should be weighted the most while median also influenced a successful prediction.

One having skill in the art will recognize that many operators may be compared and combined to provide effective predictions.

By having a fixed set of operators in a graph, Artificial Intelligence Modeling Engine 200 may optimise predictive power across different applications.

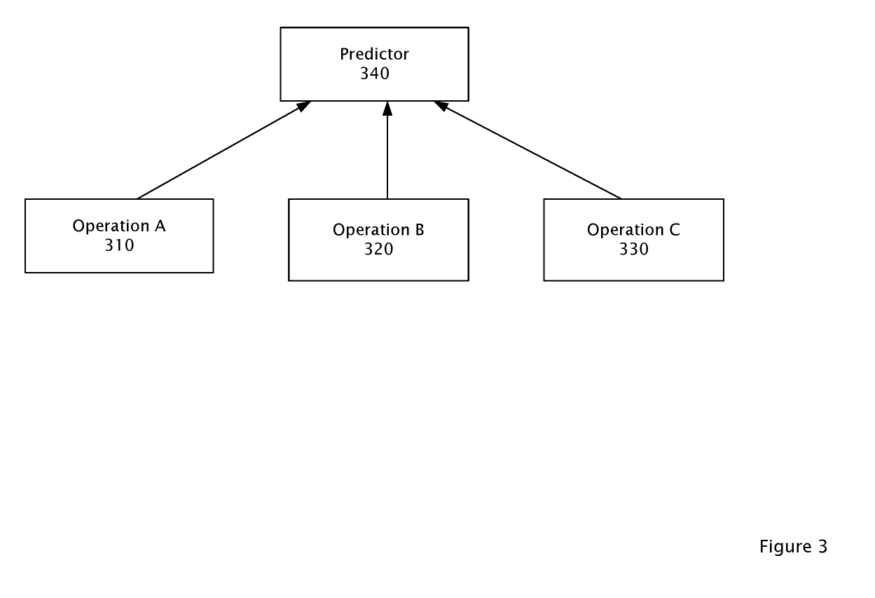

FIG. 3 illustrates a graph of another model of Artificial Intelligence Modeling Engine 200. Predictions may be based on multiple operators. For example, Operator A 310 may be a linear regression, Operator B 320 may be a decision tree, and Operator C 330 may be a non-linear regression. Data may be run through each operator, and Predictor 340 may consider all three outputs when making a prediction. Over time, Predictor 340 may learn the most effective way to combine the three inputs to optimize prediction success.

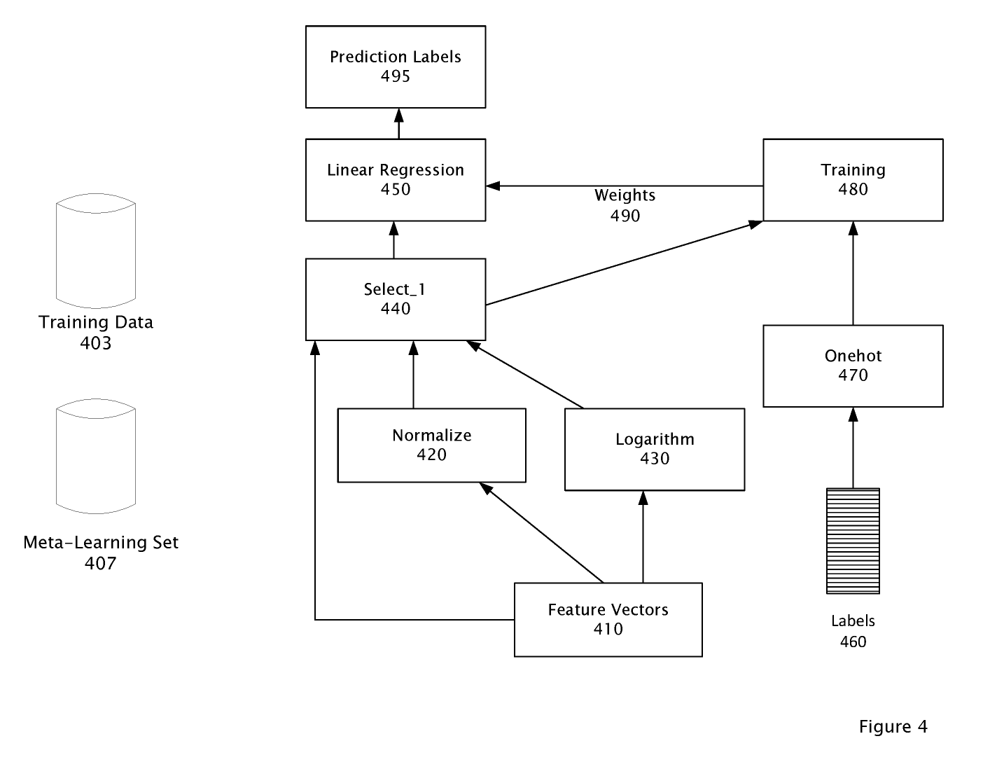

FIG. 4 is a graph illustrating an example of meta-learning in Artificial Intelligence Modeling Engine 200. Meta-learning may allow Artificial Intelligence Modeling Engine 200 to learn how to learn more effectively.

An operator may be a component that implements a step in a machine learning algorithm. Each operator may produce one or more outputs, which may be consumed by other connected operators as inputs. Operators may have at least one input. Such operators may be a data processing step.

An operator may execute a deterministic function, that may process data in a predefined manner, or its behaviors may be determined by parameters, which may be specified or learned from data. In deep learning, an operator may represent part of a neural net architecture, for example, a subset of its nodes or connections.

A operator may have a simple interface, for example, a random number generator, which may or may not require an input, and may output an array of random numbers.

More complicated interfaces may be used for other functions, for example, a Linear Regression operator. This operator may take one input array, for example, Feature Vectors 410 and may produce one output array, for example, Prediction Labels 495. Feature Vectors 410 may be a numerical representation of input values, for example, Labels 460, since such a representation may facilitate processing and statistical analysis. Internally the operator may maintain a set of numerical values, knowns as weights. The weights may be used in computing a label for a feature vector. The weights may be predefined, or they may be learned by a defined procedure.

Operators, known as meta-learning operators, may take one or more data arrays and one or more condition arrays as an input, and may produce one or more output arrays. A behavior of an operator may depend on a condition array. A condition array may be computed by the graph, or may be a small subset of the dataset. Once computed, the condition array may not change, and the operator may be deterministic. In Artificial Intelligence Modeling Engine 200, there may be two types of operators, select_n, and hyperparameter operators.

A select_n operator may take one or more input arrays, and select n of them as outputs. Its condition arrays may be the same as the input arrays but may be computed on a small portion of Training Data 403. Once a condition array is computed, when a training stage is complete, for example, the operator may have chosen n specific input arrays for outputs. This choice may not change even if the computed values change when data is processed. A select_n operator may use neural net algorithms, which may be trained while a model is being trained.

A select_n operator may change the structure of a graph. By making different choices, select_n operators essentially remove some inputs from the operator. In the example illustrated in FIG. 4, Select_1 440 removes two of the three inputs of Feature Vectors 410, Normalize 420, and Logarithm 430. In general, if there are M select_1 operators, and each picks one out of two choices, there are be 2\hat{ }M variations of instantiated graphs that may be derived from the original meta-learning graph.

A hyperparameter operator may take condition arrays as input, and may produce a series of numeric values. Those values may be fed to other operators as inputs, which may also be hyperparameter parameters, which may determine the behavior of the receiving operators. For example, a hyperparameter operator may estimate a hyperparameter K, which may determine a number of times Training Data 403 should be looped through during training.

In the example illustrated, Feature Vectors 410 may be an input for a prediction. Feature Vectors 410 may be used as input for three operators, Normalize 420, Logarithm 430, and Select_1 440.

Normalize 420 may, for example, accept a two-dimensional array, and calculate a mean and standard deviation for each dimension. The mean and standard deviation may then be used to normalize values in the array so each dimension has a zero mean and a 1.0 standard deviation in an output array.

Logarithm 430 may convert each value in Feature Vectors 410 into their corresponding logarithms.

Select_1 440 may select one input to pass on to an output. It may select one of Feature Vectors 410, Normalize 420, or Logarithm 430. Outputs of Normalize 420 and Logarithm 430, and Feature Vectors 410 may be used to determine which input may be passed as an output.

Labels 460 may be input data processed by operator Onehot 470, which may convert data from Labels 460 into binary values. For example, Onehot 460 may convert some labels into 1, indicating “Good,” while it converts others to 0, indicating “Bad.” These binary values may feed into Training 480, which may use the values to update weights for Linear Regression 450.

Linear Regression 450 may accept the output from Select_1 440 and Weights 490, and may provide Prediction Labels 495. The linear regression operator may predict binary Prediction Labels 495 using an input array selected by Select_1 440. Linear Regression 450 operator may take one row at a time from the selected array and apply a weighted linear combination to it. Linear Regression 450 may predict a 1 if a result is positive, and may predict a 0 if the result is not positive.

Weights used by Linear Regression 450 may be computed by a training operator. The training operator may take outputs from Select_1 440 and Onehot 470, using Training Data 403, to compute the weights. The weights may be computed using algorithms like logistic regression, for example.

Once computed, the weights may be fixed, and may be fed to Linear Regression 450. From this point, the graph may become deterministic and may be used to make predictions on data without labels.

Given a meta-learning graph, Artificial Intelligence Modeling Engine 200 may generate instantiated graphs for a specific dataset. This may be done using select_n and hyperparameter operators. Meta-learning may allow Artificial Intelligence Modeling Engine 200 generate instantiated graphs which work better than random ones on a dataset.

Select_n may modify a structure of a graph, while hyperparameters may define behaviors of individual operators. Select_n may be a operator, and may be implemented so choices it makes are decided by some hyperparameters. For example, Select_1 from 5 inputs may be decided by a hyperparameter of a single integer (ranging from 0-4) indicating which inputs to be passed through. The meta-learning problem may be reduced to finding optimal hyperparameters. Given some condition data D, and an arbitrary choice of parameters P, the instantiated graph—may achieve accuracy of A(D,P), after training. The meta-learning problem may become an optimization problem of finding P so the accuracy A of D/P will be maximized.

P\hat{ }=argmaxₚ A(D,P)

The optimization problem may be addressed analytically in some cases, for example, using machine learning algorithms. For example, it may be solved as a ranking problem, for example, find a best candidate from a set of potential candidates Pi, or as a prediction problem, for example, directly predict a best candidate as a regression or classification problem. One having skill in the art will recognize that other machine learning and statistical methods exist for this optimization problem.

Because condition data D may be restricted to be outputs of operators running before an operator, original user data may not be needed for meta-learning. Original data may not need to be stored, unless training a model for users. Meta-learning may be improved over time across different datasets without keeping copies of original user data.

Operators may be deep learning operators or non-deep learning. A deep learning operator may be one which learns data representations, while a non-deep operator may learn task-specific algorithms. A linear regression operator, for example, may be a non-deep learning operator. In contrast, a convolutional neural net (CNN) operator may be a deep learning operator, and may be parameterized by stripe, filters, activation, or other attributes. CNNs may be used, for example, for analyzing visual imagery or natural language processing, and may learn with less pre-processing and less human interaction than some other approaches. Deep learning operators may use neural nets. Some examples of deep learning operators include:

a multi-layer CNN operator that has been pre-trained on image data,

a pre-trained RestNet image classification operator,

a bidirectional LSTM layer, which may be parameterized by activation, and

an attention layer that stacks over LSTM.

During a training process, samples of the condition arrays, their predictions, and the trained model performance may be collected. These may be stored on the platform to enable improvements on machine learning models that estimate hyperparameters. Hyperparameters may be estimated using machine learning models.

Meta-learning may use machine learning models to predict hyperparameters. There may be more than one model used to predict different parameters.

loss_k(D_k, f_1(a_1, theta_1), f_2(a_2, theta_2), . . . )

is the loss (the amount of errors a model makes) of a graph trained on data D_k, using meta-learning models theta_1, theta_2, . . . Note that a_i are condition arrays.

Loss(theta_1, theta_2, . . . )=sum_k(loss_k(D_k, . . . ))

is the total loss on all the data D_k we have seen before. A goal may be to find the models theta_1, theta_2, . . . that minimize the total loss, that is argmin_(theta_1, theta_2, . . . ) Loss(theta_1, theta_2, . . . )

This optimization problem may be addressed using machine learning approaches, such as Bayesian network, GAN (generative adversarial network), or reinforcement learning.

Stochastic instantiation may also be used for meta-learning. When meta-learning models are used, they may produce a parameter array according to the input condition array. The parameter array may be interpreted as a set of probabilistic distribution, instead of specific real values. For example, the output parameters may be an array of 4 elements [a,b,c,d]. They may be interpreted as two normal distributions, a and b may be the means and c and d may be the standard deviations. The actual hyperparameter values used in the graph are then sampled from those distributions. In this case, the above parameter array may allow a sample of two real values to use as operator parameters. This stochastic behavior may allow a system to correct the mistakes if it starts with bad assumption, and may provide more diversified training data to improve meta-learning models.

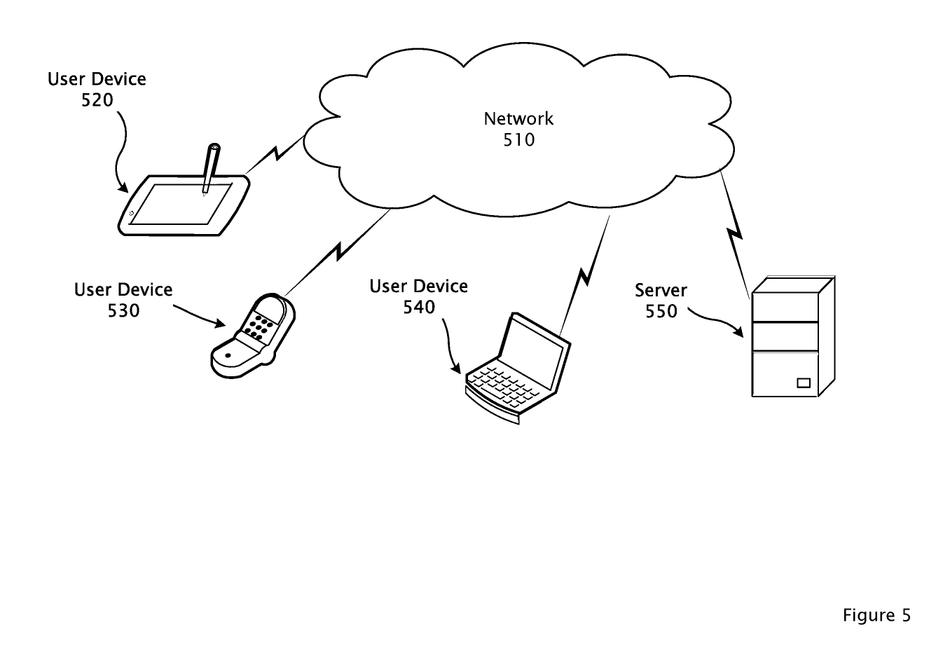

FIG. 5 is a block diagram illustrating an example of a system capable of supporting an artificial intelligence modeling engine, according to one embodiment.

Network 510 may include Wi-Fi, cellular data access methods, such as 3G or 4G LTE, Bluetooth, Near Field Communications (NFC), the internet, local area networks, wide area networks, or any combination of these or other means of providing data transfer capabilities. In one embodiment, Network 510 may comprise Ethernet connectivity. In another embodiment, Network 510 may comprise fiber optic connections.

User Device 520, 530, or 540 may have network capabilities to communicate with Server 550. Server 550 may include one or more computers, and may serve a number of roles. Server 550 may be conventionally constructed, or may be of a special purpose design for processing data obtained from artificial intelligence modeling engine. One skilled in the art will recognize that Server 550 may be of many different designs and may have different capabilities.

User Device 520, 530, or 540 may be used by users wishing to configure an artificial intelligence modeling engine, for example by accessing a website, or executing an app. Server 550 may store an artificial intelligence modeling engine, and may be used to host a website, allow configuration of the artificial intelligence modeling engine, or perform other tasks. One having skill in the art will recognize that various configurations for User Device 520, 530, or 540 and Server 550 may be used to implement an artificial intelligence modeling engine.

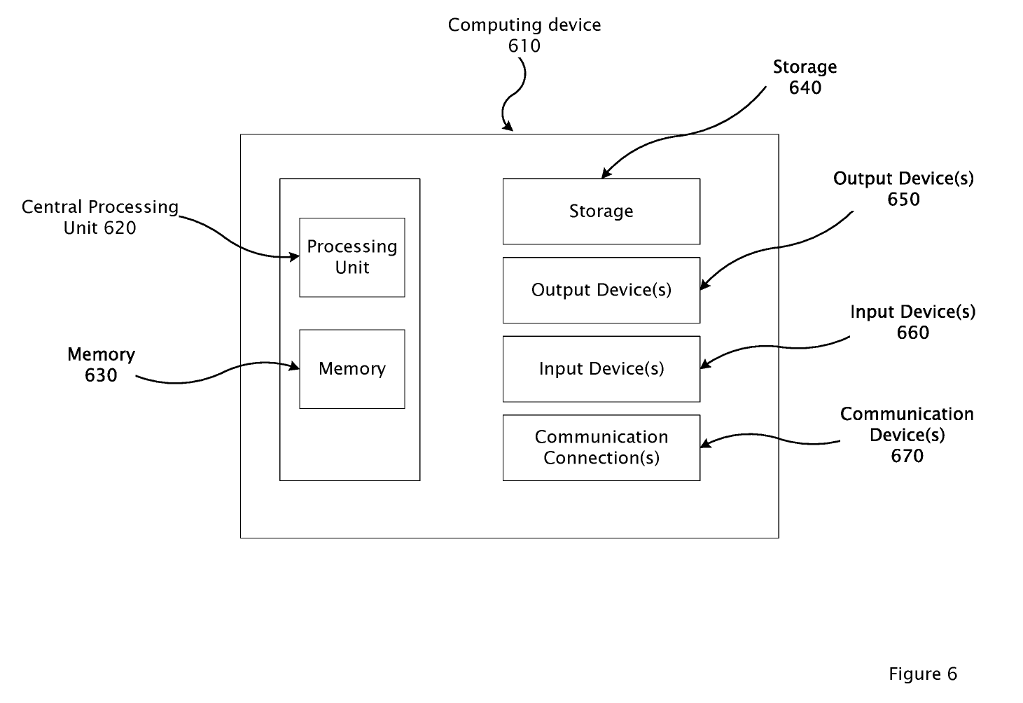

FIG. 6 is a component diagram of a computing device which may support an artificial intelligence modeling engine process according to one embodiment.

Computing Device 610 can be utilized to implement one or more computing devices, computer processes, or software operators described herein, including, for example, but not limited to a mobile device. In one example, Computing Device 610 can be used to process calculations, execute instructions, and receive and transmit digital signals. In another example, Computing Device 610 can be utilized to process calculations, execute instructions, receive and transmit digital signals, receive and transmit search queries and hypertext, and compile computer code suitable for a mobile device. Computing Device 610 can be any general or special purpose computer now known or to become known capable of performing the steps or performing the functions described herein, either in software, hardware, firmware, or a combination thereof.

In its most basic configuration, Computing Device 610 typically includes at least one Central Processing Unit (CPU) 620 and Memory 630. Depending on the exact configuration and type of Computing Device 610, Memory 630 may be volatile (such as RAM), non-volatile (such as ROM, flash memory, etc.) or some combination of the two. Additionally, Computing Device 610 may also have additional features/functionality. For example, Computing Device 610 may include multiple CPU's. The described methods may be executed in any manner by any processing unit in Computing Device 610. For example, the described process may be executed by both multiple CPUs in parallel.

Computing Device 610 may also include additional storage (removable or non-removable) including, but not limited to, magnetic or optical disks or tape. Such additional storage is illustrated by Storage 640. Computer readable storage media includes volatile and nonvolatile, removable and non-removable media implemented in any method or technology for storage of information such as computer-readable instructions, data structures, program operators or other data. Memory 630 and Storage 640 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 610. Any such computer-readable storage media may be part of Computing Device 610. But computer-readable storage media does not include transient signals.

Computing Device 610 may also contain Communications Device(s) 670 that allow the device to communicate with other devices. Communications Device(s) 670 is an example of communication media. Communication media typically embodies computer-readable instructions, data structures, program operators or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 610 may also have Input Device(s) 660 such as a keyboard, mouse, pen, voice input device, touch input device, etc. Output Device(s) 650 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A method, comprising:
training a first artificial intelligence model using training data from a first application;
optimizing a first hyperparameter operator in the first artificial intelligence model;
creating a second artificial intelligence model for a second application; and
using the first hyperparameter operator optimized during training of the first artificial intelligence model in training the second artificial intelligence model.

2. The method of claim 1 wherein the first application and the second application are the same application.

3. The method of claim 1 wherein the first application and the second application are different applications.

4. The method of claim 1 wherein the optimizing of the first hyperparameter operator is performed using machine learning algorithms or stochastic instantiation.

5. The method of claim 4 wherein the creating the second artificial intelligence model for the second application is performed automatically, wherein operators to use in the second artificial intelligence model and parameters set for the operators are selected by a second hyperparameter operator, the second hyperparameter operator using data for the second application as a condition array to select operators and set parameters.
